(19) United States
(12) Patent Application Publication
(10) Pub. No.: US 2016/0342934 A1
(43) Pub. Date: Nov. 24, 2016

(54) SYSTEM AND PROCESS FOR COMMUNICATING BETWEEN A DRONE AND A HANDHELD DEVICE

(71) Applicant: Peter Michalik, Liptovsky Hradok (SK)

(72) Inventor: Peter Michalik, Liptovsky Hradok (SK)

(21) Appl. No.: 15/161,156

(22) Filed: May 20, 2016

Related U.S. Application Data
(60) Provisional application No. 62/165,834, filed on May 22, 2015.

(51) Int. Cl. G06Q 10/08; B64C 39/02; G06Q 20/10; G05D 1/12; G06Q 30/06; H04W 4/02; G08G 5/00

(52) U.S. Cl. CPC G06Q 10/083; H04W 4/02; B64C 39/024; G08G 5/0069; G05D 1/12; G06Q 30/0635; G06Q 20/10; B64C 2201/128

(57) ABSTRACT

The disclosure relates to a process for delivering a package comprising the following steps: purchasing a package, providing an address for the package, paying for the package; delivering the package to the address via a drone. The process can also include the steps of providing at least one short range signal, reading the short range signal by the drone; and then delivering the package to the short range signal.

### CROSS REFERENCE TO REALATED APPLICATIONS

This application is a non-provisional application that hereby claims priority from U.S. Provisional Application Ser. No. 62/165,834 Filed on May 22, 2015, the disclosure of which is hereby incorporated herein by reference.

### BACKGROUND

At least one embodiment relates to a system and process for delivering goods via drones. There is at least one embodiment that relates to a system comprising at least one device for delivery and a portable electronic device for communicating with the at least one device. In addition there is at least one process for controlling the device for delivery and the portable electronic device as well.

### SUMMARY

At least one embodiment relates to a process for delivering a package comprising the following steps: purchasing a package, providing an address for the package, paying for the package; delivering the package to the address via a drone. The process can also include the steps of providing at least one short range signal, reading the short range signal by the drone; and then delivering the package to the short range signal.

In at least one embodiment, the drone is a flying drone. In at least one other embodiment the short range signal is a light. In at least one embodiment there is a step of reading the short range signal wherein this step comprises reading the light.

In at least one embodiment the short range signal comprises a strobing light in the form of a pattern.

In at least one embodiment drone reads the short range signal using a camera. In at least one embodiment the drone reads the short range signal to identify the party to receive the package.

In addition, in at least one embodiment the process can include the step of transmitting a code for controlling the transmission of the short range signal. In at least one embodiment the process includes notifying the purchaser of the time, date and location of the delivery by the drone.

In at least one embodiment the process includes opening an application on a user's portable device so as to initiate the production of the at least one short range signal.

In addition in at least one embodiment there is a system for delivering goods. The system can comprise at least one GPS tracking system, at least one data network, at least one drone for delivering at least one good, and at least one portable handheld device configured to communicate with the at least one drone to signal the drone an exact area that the drone is to deliver any particular goods.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a view of the system in action;

FIG. 2 is a schematic block diagram of the computer network for use with the system of FIG. 1;

FIG. 3 is a schematic block diagram of a server used in the computer network shown in FIG. 2;

FIG. 4 is a schematic block diagram of a portable electronic device shown in the computer network of FIG. 2;

FIG. 5 is a schematic block diagram of a drone shown with the computer network in FIG. 1 and with the system shown in FIG. 1; and

FIG. 6 is a flow chart for the process for delivering goods to users;

FIG. 7 is a process for providing user location with a handheld;

FIG. 8 is a process for colocation; and

FIG. 8A is another series of steps for an alternative delivery process.

### DETAILED DESCRIPTION

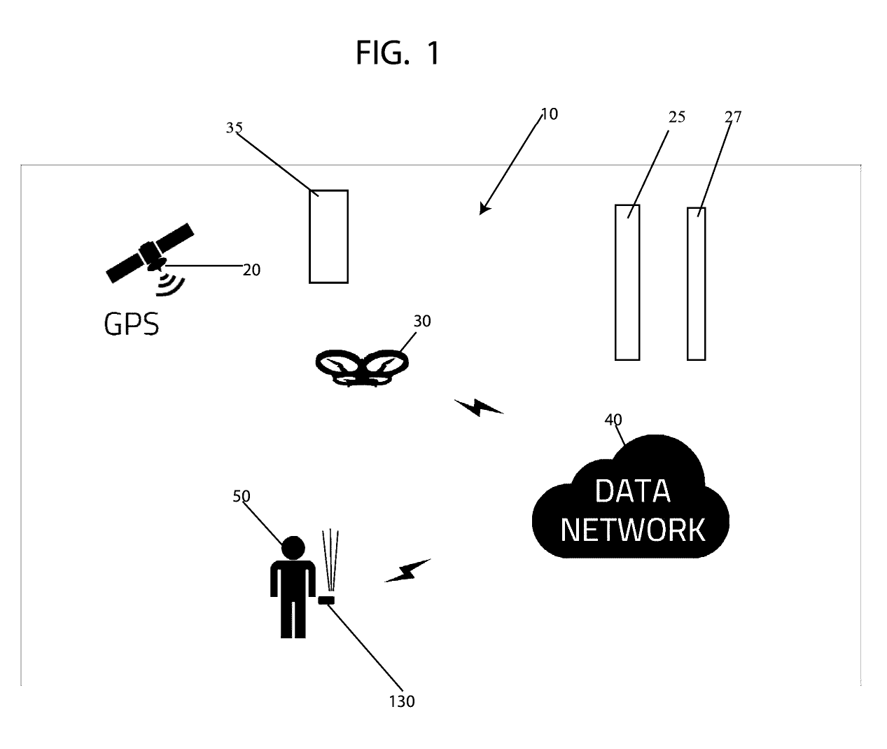

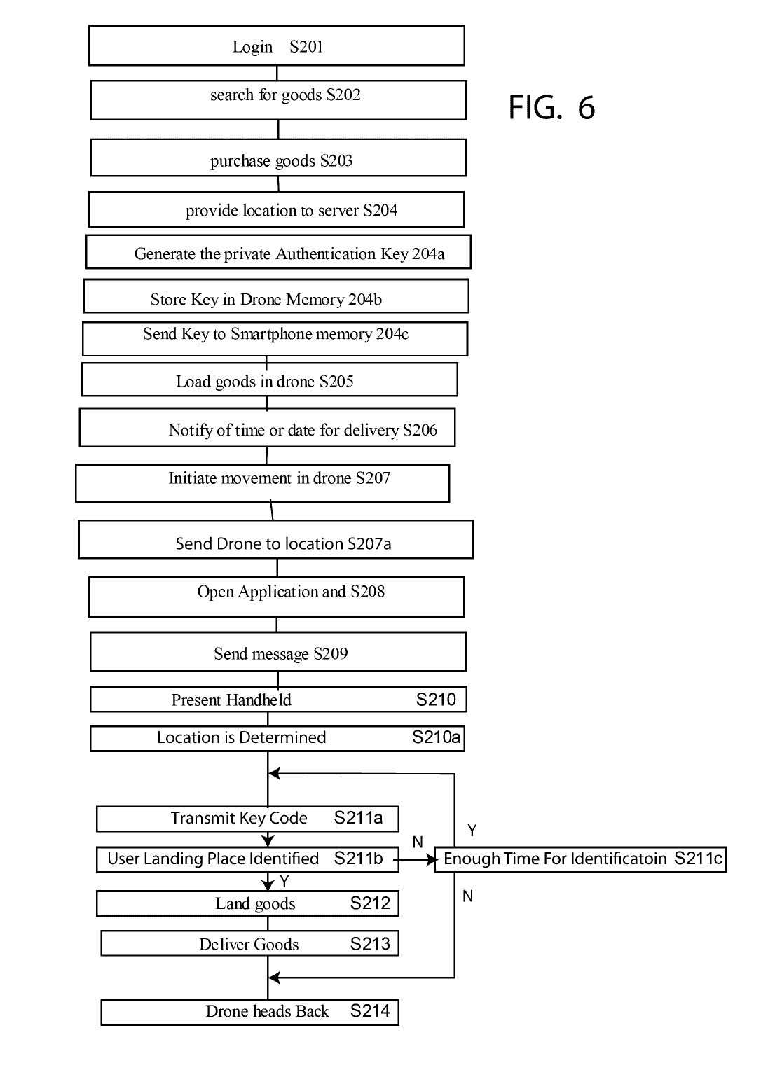

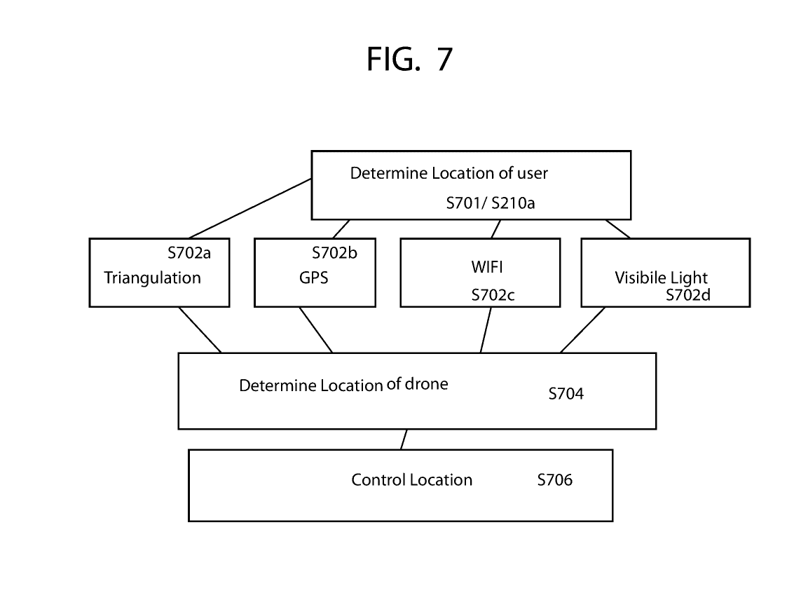

Turning now in detail to the drawings, FIG. 1 is a view of the system in action. For example, in this view, there is shown a network or system 10, which comprises a GPS communication system 20, a drone 30, a first cell tower 25, a second cell tower, a wifi network transmitter 35, a data network 40, the user 50, and a portable electronic device 130, which can be held by the user 50. With this system, once the user 50 purchases an object, that object can be transported by a drone such as drone 30, to the user 50, while communicating through data network 40, a cell tower network using triangulation or through a wifi network transmitter for geolocating a device. However, the preferred way for geolocation would be via GPS colocation via satellite tracking. A more detailed explanation of the process for delivering goods to user is shown in the flow chart in FIGS. 6 and 7.

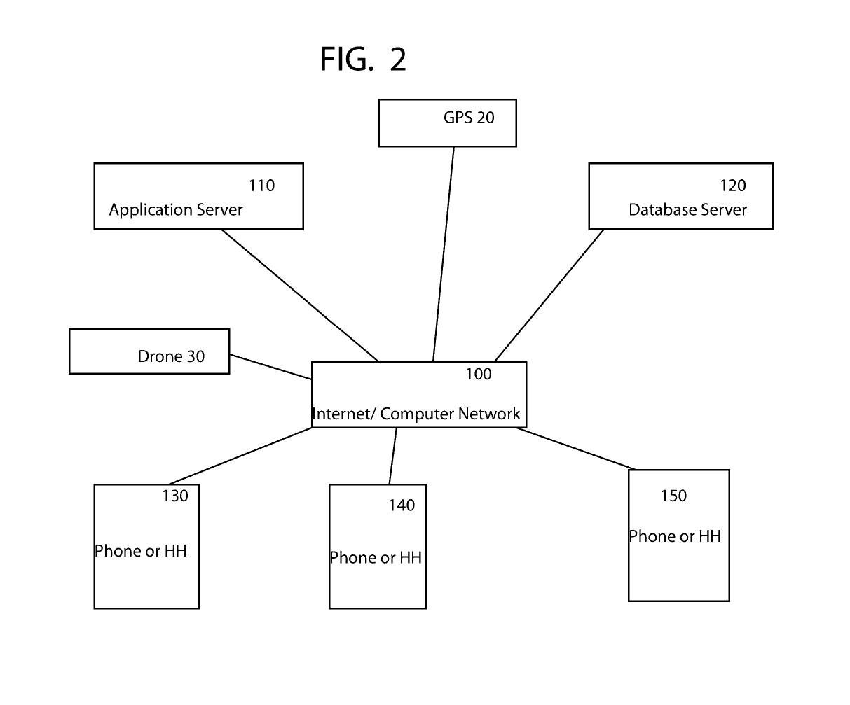

FIG. 2 shows a schematic block diagram of the plurality of electronic components that are in communication with each other in order to accomplish the process shown in FIG. 6. For example, there is shown the Internet or a computer network 100, which is in communication with a plurality of different electronic devices. For example, there is an application server 110 for running the application, which assists in connecting the user and the drone 30 carrying the object together. In addition, there is a database server 120 which is in communication with application server 110. Database server 120 includes data about the user, data about the drone, data about addresses, and any other data necessary to achieve the process shown in FIG. 6. In addition, in communication with drone 30 is a GPS communication system 20. GPS communication system 20 can be in the form of GPS receiver module, which allows for the geographic location monitoring of a drone, and at least one user via different phones or portable handheld devices 130, 140, and 150.

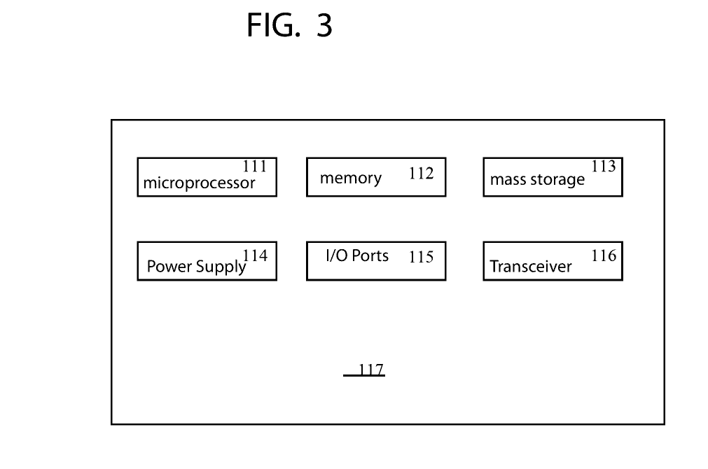

FIG. 3 shows schematic block diagram of the electronic components of a server such as application server 110, or database server 120. For example, as shown, there is a microprocessor 111, a memory 112, a mass storage 113, a power supply 114, input output ports 115, and a transceiver 116. All of these components are coupled together both communicatively and electrically via a motherboard 117. Thus, power supply 114 provides power to microprocessor 111, memory 112, mass storage 113, I/O ports 115, and transceiver 116 via motherboard 117. In addition, microprocessor 111 is configured to allow data or information to be fed from memory 112, or data to be fed through transceiver 116 into microprocessor 111. Alternatively, microprocessor 111 can receive information from I/O ports 115 wherein the user is manually inputting data such as typing on a keyboard. Once microprocessor 111 receives a series of instructions and processor 111 can initiate the process shown in FIG. 6.

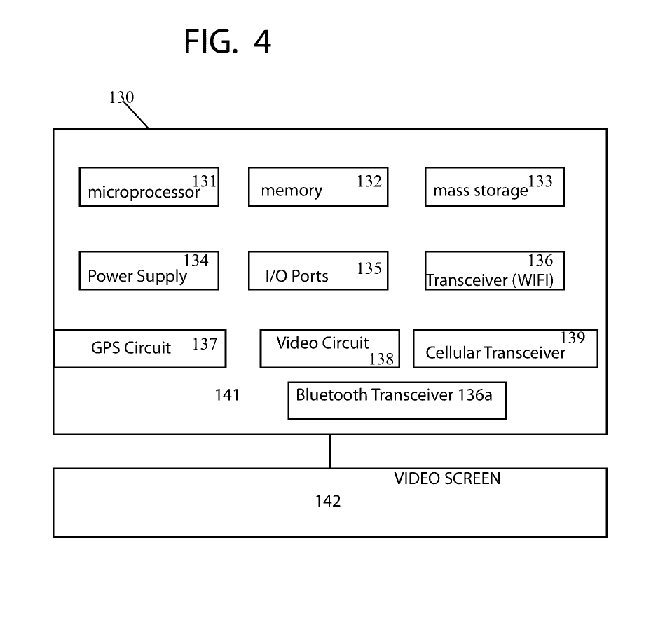

FIG. 4 shows the schematic block diagram of a portable handheld device or phone such as phone 130. In this view, there is a microprocessor 131, a memory 132, mass storage 133, a power supply 134, input output ports 135, a transceiver 136, wherein this transceiver is a Wi-Fi transceiver, a GPS circuit 137, the video circuit 138, and a cellular transceiver 139. All of these components are coupled to motherboard 141, and the each of these components receives power from power supply 134 which is fed through motherboard 141. Memory 132 is configured to act as a short-term or RAM type memory, well. Mass storage device 133 is a hard drive for storing ROM type memory. In addition there can also be a Bluetooth transceiver as well 136a. The Bluetooth transceiver can be configured to communicate wirelessly with other Bluetooth transceivers either on a drone or with other portable handheld devices or with other computers.

In addition, video circuit 138 communicates with video screen 142 to relay information that is fed from across the motherboard to provide a display on video screen 142. In addition, microprocessor 131 can receive instructions from memory 132 associated with a program or series of instructions. For example, microprocessor 131 can receive a set of instructions instructing microprocessor 131 to initiate a coded short range signal such as a strobe light or patterned light signal.

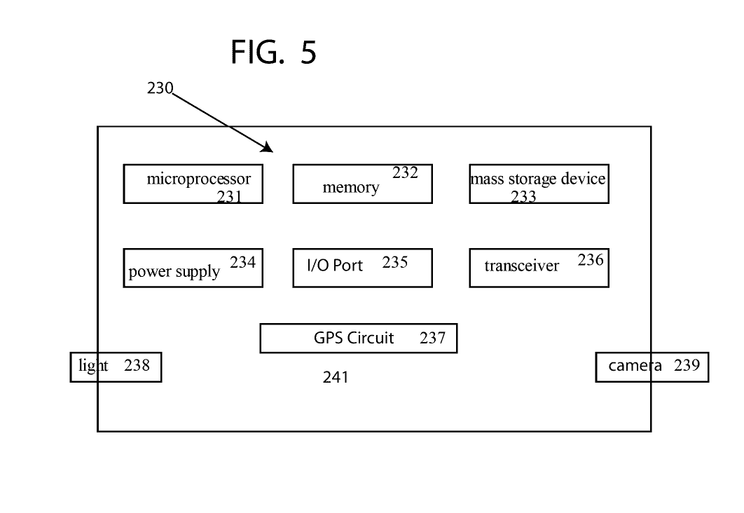

FIG. 5 is a schematic block diagram of the structure of a drone such as drone 30, provided in a layout 230. For example, there is shown a microprocessor 231, memory 232, mass storage device 233, power supply 234, input output port 235, transceiver 236, and GPS circuit 237, wherein all of these components are coupled to motherboard 241. In addition, coupled to motherboard 241 is a light 238, and a camera 239. Camera 239 is configured to read a strobe or signal from a portable electronic device such as phone or portable handheld device 130. The signal recorded by camera 239 is then fed through memory 232 into microprocessor 231, wherein the signal is then decoded and used to identify the identity of the user holding a handheld device that is emitting that particular signal. In addition, light 238 is configured to emit a signal to the handheld device for communication as well. Furthermore, the drone can also have a distance measurement sensor 242 which is used to determine the distance that the drone is positioned from a user.

In addition, through this sensor, the drone is constantly measuring the distance to the ground (earth). If the distance to the ground obtained from the drone's GPS is showing rapidly higher values that the distance measurement obtained from the separate measurement system then the drone will correct the drone's flight level height from the separate measurement system including a sensor 242 and alarm signal is sent to flight's supervisor and the drone can be temporarily set to the mode in which is even the position of the drone determined via cell tower triangulation or it is switched to manual mode where the remote operator which supervises the flight will take control over the drone's flight.

In case if the connection is dropped even connection with the control center or even cell phone signal may be lost or after the alarm signal is sent the drone can start escape maneuver when the drone will quickly increase it's height of flight level and eventually will fly away from the current position in programmed manner. After the connection is reestablished and height from GPS and height from the measuring sensor are similar, then it can be returned to normal operation mode and operator in the control center can decide about the next behavior of the drone.

FIG. 6 shows the process for communicating between a drone, a data network, a handheld electronic device. The drone could be drone 30, the data network to be named data network 40, comprising at least application server 110, and database server 120. The handheld electronic device could be in the form of phone or portable handheld device 130. For example, the system starts in step S201 where the user logs in to a server. Once the user is logged in, the user is identified by the server such as application server 110. The user can then search for goods in step S202. These could be any type of item for goods for purchase and for future delivery. Next, in step S203, the user could then purchase and then pay for these goods. Next, in step S204, the user could then provide a location to the server for delivery of these goods.

Next, in step 204a the system could generate a private authentication key. This private authentication key could be in the form of a hexadecimal number, or electronic or digital code. Next, in step 204b the key could be stored in the drone's memory such as memory 232. Next, in step 204c the key could be sent to the smartphone application and then downloaded to the smartphone.

Next, in step S205 the system could then load the goods with the drone for future delivery. Next, in step S206, the system could then notify the user of the time, date, and location of delivery. This notification could be in the form of an email, or text message, a phone call, or any other type of automatic messaging system. Next, in step S207 the system initiates movement in the drone so that the drone can then move to the location for delivery and deliver the goods to that location in step S207a. During the time that the drone is flying, in step S207b, the drone can measure the distance of the drone between the drone and another objection using the drone distance sensor 242. If the drone falls below a certain altitude or if the drone comes to close to another object, the user controlling the drone can then correct the positioning of the drone and its flight path.

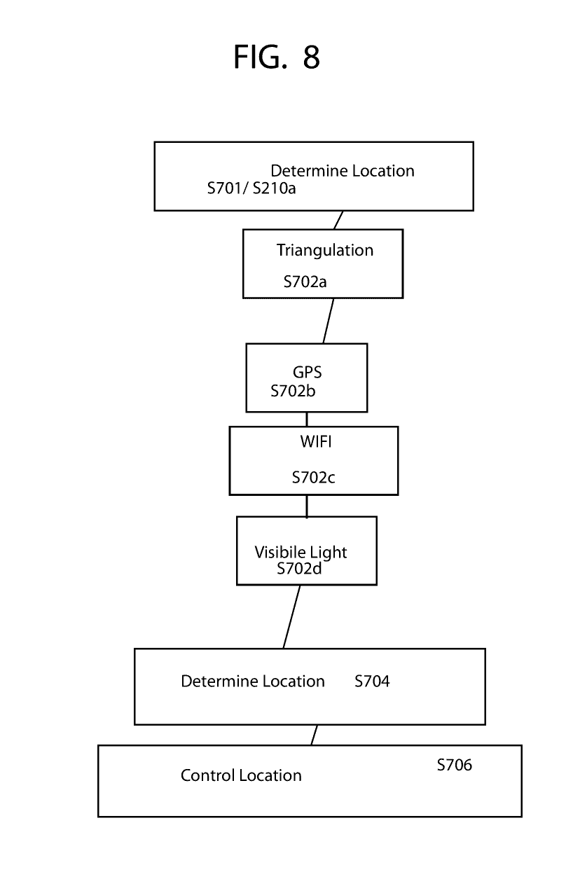

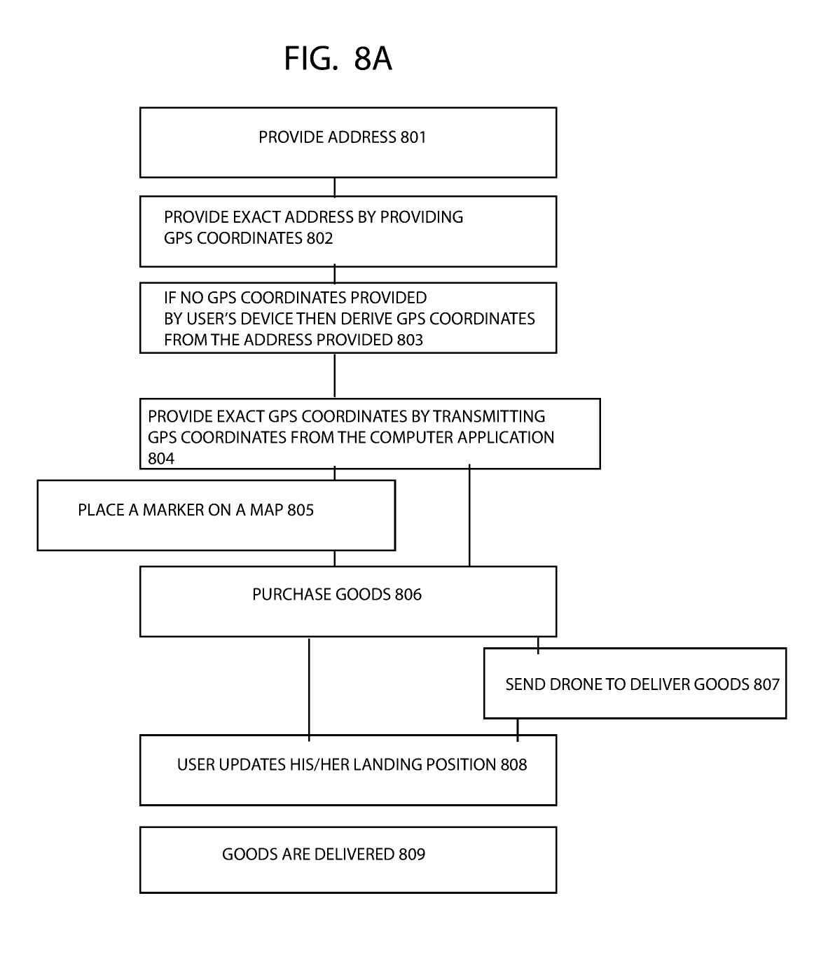

Before, during, or after the drone is moving towards location, either the user, or the system can open an application on the user's portable handheld device in step S208. Next, in step S209 the system can send a message to the user that the item is being delivered by the drone. Next, in step S210, the user presents his or her portable handheld device. Next in step 210a the location is determined by the system. This location process is shown in greater detail in FIGS. 7 and 8.

In addition in step 211a this key is transmitted to the drone's camera via the user's smartphone flashlight, display another visible or invisible light based communication method. This signal is compared with the stored key. This short range or short-term signal in step S211 a could be in the form of any type of suitable signal but in at least one embodiment is in the form of a light. The light could be in the form of a strobe or pulsing light which is pulsing in a pattern that is sufficient to identify the user, and the landing location or at least the user's handheld electronic device. As indicated above, this pattern is created using the user's smartphone flash or display. Next, in step 211b the drone compares the signal sent from the smartphone to the drone's camera or light sensitive sensor.

Next in step 211c the drone connects if the signal matches. However, in step 211c if the drone does not receive the signal or if the keys do not match each other or if the drone does not receive any signal then the drone hovers in position for awhile and waits until another means of connection is made such as via WIFI or Bluetooth or similar wireless waves or light based communication.

Alternatively, in step 211d the drone could send a signal back for reading by the portable communication device. If the portable communication device such as a smartphone receives and confirms this signal then in step 211e it sends a signal to the drone to deliver the goods. Next in step 211f the drone returns back to the base when the battery for the drone starts to run down.

In at least one embodiment, the landing location will be determined by laying of the smartphone on the ground with light emitter pointing upwards while transmitting the identification key. User will mark by this method safe environment for the landing of the drone. The drone will land upon the smartphone safely without damaging it.

Alternatively if there is a connection between the smartphone and the drone and received key is identical with stored key then the drone lands with the goods in step 212

Next, with the landing, that the drone could then in step S213 deliver these goods. Once these goods are delivered the drone in step S214 could then head back.

FIG. 7 is the process for providing the location of the user with the handheld. For example, a more definite location of both the user and his device such as a cell phone and the location of the drone is determined. For example, in step S701/S210A the system can determine the location of the user using a number of different services. For example, the system can determine the location through triangulation in step S702a, or via GPS location in step S702b, or through WIFI location in step S702c or through the spotting of visible light in step S702d. The step of determining through triangulation occurs via locating a cellular signal via a plurality of different cellular towers 25 and 27. The triangulation occurs via at least three cellular towers locating a device such as a user's device providing the third location via triangulation. Then this user's device 130 which can include a GPRS or CDMA or LTE chip can then provide its location to the system via a signal from this chip. Conversely the drone 30 can include a cellular telephone can also provide this triangulation signal. The location of this device can also be through a GPS signal via a GPS communication system 20 which can comprise a satellite. Alternatively the tracking can be through a WIFI network such as the user's WIFI network wherein when there is a user located adjacent to his or her WIFI network the portable device 130 can then have its location pinpointed via this WIFI network. If the device is the drone, the user can allow access for the drone to the WIFI network as well. Alternatively visible light can be projected either from the drone 30 or from the user's portable device 130 so that the other object can identify the location of the other object as well as authenticate the identity of the user.

FIG. 8 shows this process for co-location via a more sequential method wherein the user's device is located first via triangulation in step S702a, next located via GPS in step S702b, next located via WIFI in step S702c, and next located via visible light in step S702d. In at least one embodiment, the connection or authentication of the devices can be performed via a WIFI to WIFI connection between the drone and the user's handset using a handshake key method. Next the system can determine the location of the drone through these sequential steps as well. Finally, once both devices are co-located, the user can then take control of the region to have the goods delivered in step S706. For example, the user can provide a guidance location via his portable device 130 to direct the drone to drop the goods at a particular pinpointed location either shown in a map or by locating the portable device 130 and laying it on the ground. Now that the drone has a handshake co-location communication with the electronic device, this drone can then immediately spot the device and land the drone on the portable electronic device.

FIG. 8A shows an alternative method for connecting the user with the drone. For example, when the user will make his order he will provide his delivery address in step 801 and eventually exact GPS on the map in the browser while ordering in step 802. If the GPS coordinates are not present then rough GPS coordinates corresponding to the delivery address will be acquired from the maps or database in step 803. Next, the user can be asked to provide exact location which can be achieved from the App on the smartphone when the user will stand on the pretended landing place and in the App on his smartphone he will confirm that exact place and actual GPS coordinates will be sent to the server in step 804. If the user is not able at the moment be on the delivery location he can specify the landing location by placing a marker on the map in his smartphone's app on in the browser on the webpage in optional step 805. Next, the user purchases the goods in step 806. Next, the drone is sent to deliver the goods in optional step 807. When the drone is on the way, the user can update the landing position in the opened application 808 on his smartphone in the same manner. Next, in step 809 the goods are delivered to the user. This step can include any one of the steps shown in FIG. 8 for further location and authentication of the user with respect to the drone.

In all, there is provided a system and process for controlling the precise delivery of goods to a user in a controlled manner.

Accordingly, while at least one embodiment of the present invention has been shown and described, it is obvious that many changes and modifications may be made thereunto without departing from the spirit and scope of the invention.

What is claimed is:

1. A process for delivering a package comprising the following steps:
a) purchasing a package;
b) providing an address;
c) paying for said package;
d) delivering said package to said address via a drone;
e) providing at least one short range signal;
f) reading via said drone said short range signal;
g) matching said short range signal with a key; and
h) delivering said package to said short range signal.

2. The process as in claim 1, wherein said drone is a flying drone.

3. The process as in claim 1, wherein said short range signal is a light.

4. The process as in claim 3, wherein said step of reading said short range signal comprises reading said light sent from a portable electronic device.

5. The process as in claim 1, wherein said step of providing at least one short range signal comprises providing at least one strobing light in a form of a pattern.

6. The process as in claim 1, wherein said step of reading via said drone said short range signal comprises reading via a camera on said drone said short range signal.

7. The process as in claim 6, wherein said step of delivering said package to said short range signal comprises identifying said short range signal as an identity signal of a party to receive the package.

8. The process as in claim 1, further comprising the step of transmitting a code for controlling a transmission of at least one short range signal.

9. The process as in claim 1 further comprising the step of notifying the purchaser of a time, date and location of a delivery by the drone.

10. The process as in claim 1, further comprising the step of opening an application on a user's portable device so as to initiate a production of at least one short range signal.

11. The process as in claim 1, further comprising the step of determining a location of a user's device.

12. The process as in claim 11, wherein the step of determining the location of a user's device comprises determining via at least one of the following methods: via triangulation of the user's device via cellular communication, via GPS location, via WIFI location, and via visible light location.

13. The process as in claim 12 wherein the step of determining the location of a user's device comprises determining at least two of the following methods, triangulation of the user's device via cellular communication, via GPS location, via WIFI location, and via visible light location.

14. The process as in claim 1, further comprising the step of determining a location of a drone via at least one of the following methods: via triangulation of a user's device via cellular communication, via GPS location, via WIFI location, and via visible light location.

15. The process as in claim 1, wherein the step of determining a location of the drone comprises determining via at least two of the following methods: triangulation of a user's device via cellular communication, via GPS location, via WIFI location, and via visible light location.

16. A system for delivering goods comprising:
a. at least one GPS tracking system;
b. at least one data network;
c. at least one drone for delivering at least one good; and
d. at least one portable handheld device configured to communicate with at least one drone to signal said drone an exact area that the drone is to deliver any particular goods.

17. The system as in claim 16, further comprising a plurality of cellular towers, wherein said at least one data network in combination with the system is configured to determine a location of said portable handheld device via at least one of the following methods:
triangulation of a user's device via cellular communication,
location via GPS location,
location via WIFI location, and
location via visible light location.

18. The system as in claim 16 further comprising a plurality of cellular towers, wherein said at least one data network in combination with the system is configured to determine a location of said drone via at least one of the following methods: triangulation of a user's device via cellular communication, via GPS location, via WIFI location, and via visible light location.

19. The system as in claim 16, wherein said at least one portable handheld device further comprises a strobe light configured to provide a flashing light beacon to said drone to communicate a key to said drone.

20. The system as in claim 16, wherein the system further comprises a server and wherein said drone further comprises at least one distance sensor configured to determine the distance that the drone is located from another object, wherein the drone is configured to communicate this distance information to said at least one server.
